(19) United States
(12) Patent Application Publication
(10) Pub. No.: US 2016/0203158 A1
(43) Pub. Date: Jul. 14, 2016

(54) METADATA DATA CATALOG

(71) Applicant: BANK OF AMERICA CORPORATION, Charlotte, NC (US)

(72) Inventors: John H. Kling, Charlotte, NC (US); Lawrence R. LaBella, Charlotte, NC (US); Ronald W. Ritchey, Centreville, VA (US)

(21) Appl. No.: 14/594,750

(22) Filed: Jan. 12, 2015

(51) Int. Cl. G06F 17/30

(52) U.S. Cl. CPC G06F 17/30174; G06F 17/30345; G06F 17/30598

(57) ABSTRACT

In certain embodiments, a system maintains a plurality of metadata elements. Each metadata element indicates a current classification value for user data described by that metadata element. The system detects the occurrence of an event and automatically determines which of the metadata elements are affected by the event. For each metadata element affected by the event, the system automatically determines an updated classification value for the user data described by that metadata element and dynamically modifies the metadata element to indicate the updated classification value.

### TECHNICAL FIELD

Particular embodiments of the invention relate generally to the field of data, and more particularly to a metadata data catalog.

### BACKGROUND

One way to classify data is through the use of metadata. Generally, metadata is used to describe digital data. Metadata may describe the contents and context of data files. In some instances metadata data may be described by a number of categories. Further, data may, in some instances, be stored on multiple physical devices. Metadata is useful in allowing a user to determine the characteristics of a digital data source and make decisions based on those characteristics.

### SUMMARY

In certain embodiments, a system maintains a plurality of metadata elements. Each metadata element indicates a current classification value for user data described by that metadata element. The system detects the occurrence of an event and automatically determines which of the metadata elements are affected by the event. For each metadata element affected by the event, the system automatically determines an updated classification value for the user data described by that metadata element and dynamically modifies the metadata element to indicate the updated classification value.

Certain embodiments of the present disclosure may provide one or more technical advantages. For example, a technical advantage of one embodiment includes classifying digital data. A technical advantage of an embodiment includes controlling access to digital files. A technical advantage of an embodiment includes changing the classification of data across multiple platforms. For example, a system may detect a trigger, such as a user-indicated event or a time-based event, and may update the classification for the affected data, which may span multiple platforms in certain embodiments.

Certain embodiments of the present disclosure include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example block diagram of a system for a metadata data catalog;

FIG. 2 illustrates an example block diagram of a module;

FIG. 3 is an example flowchart for a metadata catalog; and

FIG. 4 is an example flowchart for dynamically modifying a metadata element.

### DETAILED DESCRIPTION

A basic and pervasive problem facing businesses is that increasing volumes of data must be tracked and safeguarded according to increasingly complex combinations of legal, regulatory, and business requirements. Conventional methods for tracking and safeguarding data involve manually designating data as either confidential or non-confidential. The conventional methods may be prone to error and are no longer sufficient. For example, as requirements and status change, it may be difficult to identify and change all of the affected data protections using a manual process.

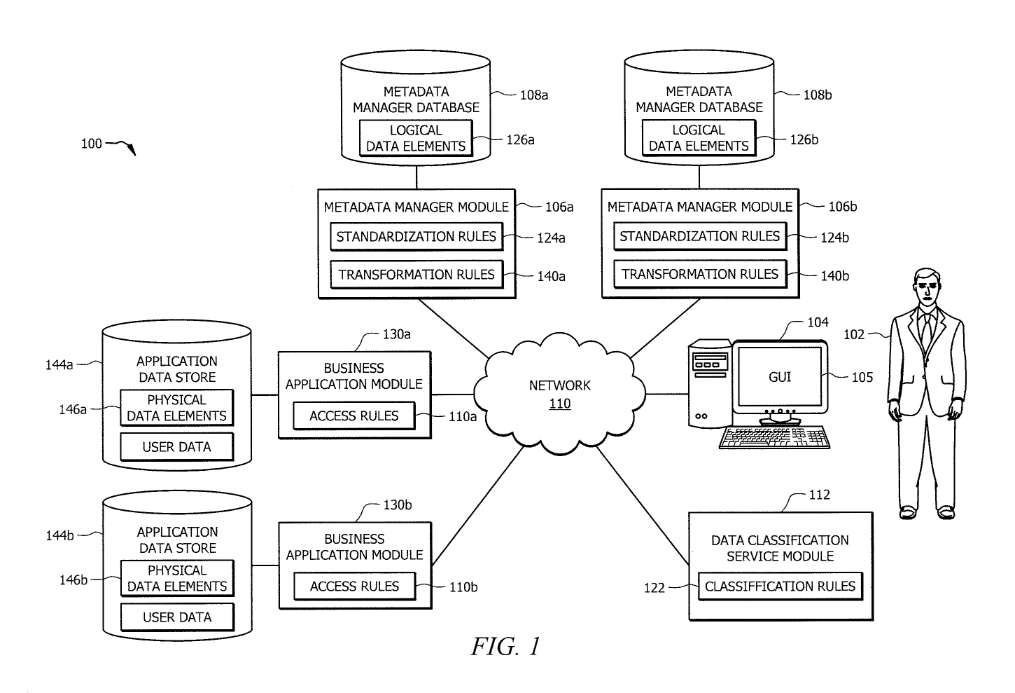

To meet current and future needs, a broader, flexible classification approach is called for. A flexible classification approach may classify data along multiple dimensions, acknowledge and provide for changes to classification based on time or other trigger events, and/or allow for protections to be automated and dynamic. For example, an aggregate risk may be determined dynamically as requirements and status change, and changes may be made to the protections that are commensurate with the aggregate risk. Embodiments of the present disclosure may provide a flexible classification approach, as further described with respect to FIGS. 1-4 below, like numerals being used for like and corresponding parts of the various figures.

FIG. 1 illustrates an example block diagram of a system 100 for a metadata data catalog. System 100 may include one more of each of the following: users 102, devices 104, data classification service modules 112, business application modules 130, application data stores 144, metadata manager modules 106, and/or metadata manager databases 108 communicatively coupled by network 110. In general, system 100 maintains user data, such as a database entry, an account, a computer file (e.g., a word processing file, an email, a spreadsheet, a presentation file, etc.), or any other suitable grouping of digital data associated with users 102. System 100 also maintains metadata elements that describe the user data. As examples, metadata may describe when the user data was created, when the user data was modified, which users 102 have accessed the user data, and so on. The metadata may also indicate a current classification value for user data. As an example, a metadata element may classify a financial report as confidential.

The classification value associated with user data may be changed in response to an event. In some embodiments, user 102, user device 104, may generate an event. For example, an authorized user 102 may input information into device 104 indicating that the financial report has been approved for publication. Device 104 may send the publication event to data classification service module 112 via network 110. Data classification service module 112 communicates the event to an appropriate metadata manager module 106 to update a logical data element 126 associated with the financial report. Thus, logical data element 126 reflects that, as a result of the publication event, the classification value of the financial report has changed from confidential to non-confidential. Metadata manager module 106 communicates the updated logical data element 126 to an appropriate business application module 130 where access control is checked and a corresponding physical data element 146 is updated. The physical data element 146 may exist on hardware (e.g., a source that stores the affected user data, such as the financial report) and may be managed according to access rules that define permissions for modifying the physical data element 146.

In some embodiments, user 102 includes clients, customers, employees, entities, or automated systems that can utilize system 100. As an example, an automated system may monitor or receive information from any suitable source and may generate an event based on the information. Examples of sources may include a person, one or more documents (such as a spreadsheet that contains data), the Internet (which may include articles and other information containing data), an open source intelligence report, a media outlet such as a television station or a radio station that broadcasts information), a clock or calendar, any other suitable source of information, or any combination of the proceeding. Certain users 102, such as employees or other persons, may interact with system 100 via device 104. Other users 102, such as automated systems, may run on device 104 (which may refer to any suitable computing resources). In general, device 104 sends event information to data classification service module 112 via network 110.

Network 110 facilitates communications between device 104, data classification service module 112, metadata manager 106, business application module 130, and/or any other suitable device. This disclosure contemplates any suitable network 110 operable to facilitate communication between the components of system 100. Network 110 may include any interconnecting system capable of transmitting audio, video, signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100. This disclosure contemplates end networks having one or more of the described properties of network 110.

In some embodiments device 104 may be representative of a personal computer, an electronic notebook, a cellular telephone, an electronic tablet device, a laptop, a personal digital assistant (PDA), or any other suitable device (wireless or otherwise: some of which can perform web browsing), component, or element capable of accessing one or more elements within system 100. Device 104 may optionally comprise any suitable interface for a user such as a video camera, a microphone, a keyboard, a set of buttons, a mouse, a touch-sensitive display, a touch-sensitive area, or any other appropriate equipment according to particular configurations and arrangements. In addition, device 104 may contain an element or set of elements designed specifically for communications involving system 100. Such elements may be fabricated or produced specifically for use in system 100. Although examples of device 104 could include end user devices in certain embodiments, device 104 need not be limited to end user devices. For example, for embodiments in which an automated system acts as a user 102, the device 104 that runs the automated system may be a server or an enterprise-level computing system.

In some embodiments, device 104 may include a graphical user interface (GUI) 105. GUI 105 is generally operable to tailor and filter data entered by and presented to user 102. GUI 105 may provide user 102 with an efficient and user-friendly presentation of information and allow user 102 to input an event. GUI 105 may comprise a plurality of displays having interactive fields, pull-down lists, and buttons operated by user 102. GUI 105 may include multiple levels of abstraction including groupings and boundaries. It should be understood that the term GUI 105 may be used in the singular or in the plural to describe one or more GUIs 105 and each of the displays of a particular GUI 105.

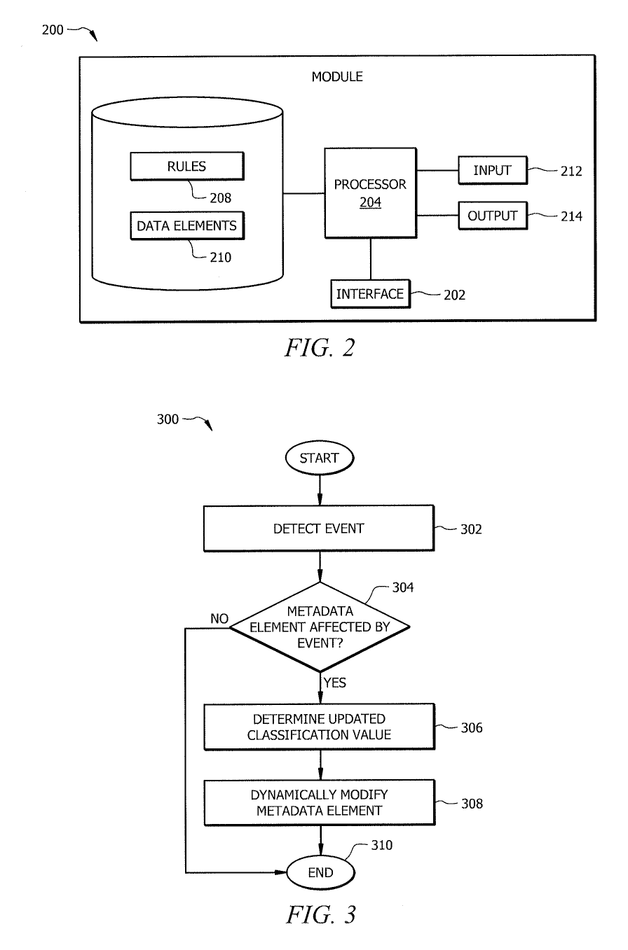

In some embodiments, system 100 may include one or more data classification service modules 112. In general, data classification service module 112 detects the occurrence of an event associated with a metadata element, applies classification rules 122 to automatically determine an updated classification value for user data described by a metadata element, and communicates instructions to metadata manager module 106 via network 110. Specific components of data classification service module 112 are described in more detail in FIG. 2.

In some embodiments, data classification service module 112 may receive an event from device 104. An event may include anything that could change the classification of user data. For example, an event could indicate that user data is no longer confidential (e.g., a report that was classified as confidential before being filed with the Securities and Exchange Commission (SEC) becomes public information after being filed with the SEC and thus may be reclassified as non-confidential). An event could also indicate that a party has transacted Y number of payment card transactions and, as a result, the party should be reclassified from a current payment card industry (PCI) compliance level X to a new PCI compliance level Y. As another example, an event may be a time-based event (e.g., occurs after the expiry of a timer or at a pre-defined date or time). As a further example, an event may be initiated by a user. For example, user 102 could communicate an event to device 104 via GUI 105. In some embodiments, device 104 communicates the event to data classification service module 112 via network 110.

In the illustrated embodiment, data classification service module 112 contains classification rules 112. Data classification service module 112 may utilize classification rules 122 to automatically determine which, if any, metadata elements are affected by the event. The basic principle of data classification is that data classification is based on business and regulatory requirements. Data classification rules are expressed in business terms. Each classification rule may be defined in a table and linked to one or more logical data elements 126 or a groups of logical data elements 126. In general, data classification service module 112 applies classification rules 122 to an event to determine which, if any, metadata elements require an updated classification value. For example, a classification value could indicate whether user data located in a physical data element is confidential. As a further example, a classification value could include a PCI compliance level for certain user data associated with a financial account.

Data classification service module 112, through application of classification rules 122, may determine that user data that is categorized as confidential may no longer need to be categorized as confidential, or vice versa. If data classification service module 112 determines that a classification value associated with user data needs to be updated, data classification service module 112 may communicate instructions for updating the classification value to one or more metadata manager modules 106 via network 110, each metadata manager module 106 associated with a logical data element 126 that corresponds to the affected user data.

System 100 may also include metadata manager module 106. Metadata manager module 106 facilitates dynamically modifying a metadata element to indicate an updated classification value. In general, metadata module 106 receives instructions for updating a classification value, applies standardization rules 124 and transformation rules 140 to a logical data element 126, and communicates the logical data element 126 to one or more business applications modules 130 via network 110. Specific components of data classification service module 112 are described in more detail in FIG. 2.

In the illustrated embodiment, metadata manager module 106 is communicatively coupled to metadata manager database 108. Once metadata manager 106 receives instructions from data classification service module 112, metadata manager module 106 may request one or more logical data elements 126 associated with the instructions from metadata manager database 108. Metadata manager database may provide the requested logical data elements to metadata manager 106 via network 110.

In general, metadata manager database 108 includes logical data elements 126 and/or other suitable data. Metadata manager database 108 may refer to any suitable device capable of storing and facilitating retrieval of data and/or instructions. Examples of metadata manager database 108 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates metadata manager database 108 as external to metadata manager module 106, it should be understood that metadata manager database 108 may be internal or external to metadata manager module 106 depending on particular implementations. Also, metadata manager database 108 may be separate from or integral to other memory devices to achieve any suitable arrangement of memory devices for use in system 100.

Metadata manager module 106 includes standardization rules 124. Standardization rules 124 generally refer to logic, rules, algorithms, code, tables, and/or other suitable instructions embodied in a computer-readable storage medium for performing the described functions and operations of data classification service module 112. For example, standardization rules 124 facilitate transforming instructions received from data classification service module 112 via network 110 into a common data format associated with metadata manager module 106. Each metadata manager module 106 may contain the same or different standardization rules 124. In an embodiment, metadata manager module 106 and/or an associated business application module 130 may work with data in a particular format. In this example, standardization rules 124 transform instructions provided by data classification service module 112 into the suitable format. While illustrated as including a particular module, standardization rules 124 may include any suitable information for use in the operation of data classification metadata manager module 106.

In the illustrated embodiment, metadata manager module 106 includes transformation rules 140. Transformation rules 140 generally refer to logic, rules, algorithms, code, tables, and/or other suitable instructions embodied in a computer-readable storage medium for performing the described functions and operations of data classification service module 112. For example, metadata manager module 106 may apply transformation rules 140 to the received logical data element 126 to update its classification value. For example, transformation rules 140 could change a logical data element's classification from confidential to public or vice versa. In an embodiment, system 100 may apply transformation rules 140 to a plurality of logical data elements 126. In an example, the same or difference transformation rules 140 may be applied to each logical data element 126. Each logical data element 126 may be associated with one or more physical data elements 146. In an embodiment, metadata manager module 106 maps the updated logical data element 126 to one or more physical data elements 146 and communicates the updated logical data element 126 to one or more business application modules 130 associated with the one or more physical data elements 146 via network 110.

In some embodiments, system 100 may include one or more business application modules 130. In general, business application module 130 receives an updated logical data element classification associated with a physical data element 146, determines whether the source of event has permission to modify the classification value of physical data element 146, and communicates instructions to change the classification value of physical data element 146 located application data store 144.

Application data store 144 may refer to any suitable device capable of storing and facilitating retrieval of data and/or instructions. In general, application data store includes physical data elements 146, user data, and/or any other suitable data. Examples of application data store 144 include computer memory (for example, RAM or ROM), mass storage media (for example, a hard disk), removable storage media (for example, a CD of DVD), database and/or network storage (for example, a server), and/or or any other volatile or non-volatile, non-transitory computer-readable memory devices that store one or more files, lists, tables, or other arrangements of information. Although FIG. 1 illustrates application data store 144 as external to business application module 130, it should be understood that data store 144 may be internal or external to business application module 130, depending on particular implementations. Also, data store may be separate from or integral to other memory devices to achieve any suitable arrangement of memory devices for use in system 100.

Business application module 130 receives an updated logical data element 126 from metadata manager module 106 via network 110. In an embodiment, business application module 130 applies access rules 110 to the received information. Generally, access rules 110 determine whether the source of the event has permission to modify the physical data element 146. For example, some user data may be classified in a way that only certain sources may update the corresponding physical data element. For example, a junior level employee may not have permission to make an SEC report public, but a senior level employee may have permission to make the SEC report public. In this example, business application module 130 may not update a corresponding physical data element 146 if the junior level employee attempts to make the SEC report public. However, if the senior level employee attempts to make the SEC report public, business application module 130 will utilize information received from metadata manager module 106 to update the physical data element 146 associated with the SEC report.

FIG. 2 illustrates an example block diagram of a module. Generally, module 200 may be representative of modules illustrated in system 100. For example, module 200 may illustrate the components of metadata manager module 106, data classification service module 112, and/or business application module 130. In some embodiments, module 200 may refer to any suitable combination of hardware and/or software implemented in one or more modules to process data and provide the described functions and operations. In some embodiments, the functions and operations described herein may be performed by a pool of modules 200. In some embodiments, data module 200 may include, for example, a mainframe, server, host computer, workstation, web server, file server, a personal computer such as a laptop, or any other suitable device operable to process data. In some embodiments, module 200 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In the illustrated embodiment, module 200 includes interface 202, processor 204, memory 206, input 212, and output 214. Memory 206 may refer to any suitable device capable of storing and facilitating retrieval of data and/or instructions. Examples of memory 206 include computer memory (for example RAM or ROM), mass storage media (for example, a hard disk), removable storage media (for example, a CD or DVD), database and/or network storage (for example, a server), and/or or any other volatile or non-volatile, non-transitory computer-readable memory devices that store one or more files, lists, tables, or other arrangements of information. Although FIG. 2 illustrates memory 206 as internal to module 200, it should be understood that memory 206 may be internal or external to module 200, depending on particular implementations. Also, memory 206 may be separate from or integral to other memory devices to achieve any suitable arrangement of memory devices for use in system 200.

Memory 206 is generally operable to store rules 208 and data elements 210. Rules 208 generally refer to logic, rules, algorithms, code, tables, and/or other suitable instructions embodied in a computer-readable storage medium for performing the described functions and operations of module 200. For example, rules 208 may be representative of classification rules 122, standardization rules 124, transformation rules 140, and/or access rules 110. While illustrated as including a particular module, rules 208 may include any suitable information for use in the operation of module 200.

Memory 206 may also store data elements 210. Data elements 210 generally refer to logic, rules, algorithms, code, tables, and/or other suitable instructions embodied in a computer-readable storage medium for performing the described functions and operations of module 200. For example, data elements 210 could include logical data elements, physical data elements, user data, any other suitable data, or any combination of the preceding. While illustrated as including a particular module, data elements 210 may include any suitable information for use in the operation of module 200.

Memory 206 communicatively couples to processor 204. Processor 204 is generally operable to execute rules 208 stored in memory 206. Processor 204 may comprise any suitable combination of hardware and software implemented in one or more modules to execute instructions and manipulate data to perform the described functions for module 200. In some embodiments, processor 204 may include, for example, one or more computers, one or more central processing units (CPUs), one or more microprocessors, one or more applications, and/or other logic.

In some embodiments, interface 202 is communicatively coupled to processor 204 and may refer to any suitable device operable to receive input for module 200, send output from module 200, perform suitable processing of the input or output or both, communicate to other devices, or any combination of the preceding. Interface 202 may include appropriate hardware (e.g. modem, network interface card, etc.) and software, including protocol conversion and data processing capabilities, to communicate through network 110 or other communication system that allows module 200 to communicate to other devices. Interface 202 may include any suitable software operable to access data from various devices such as device 104, data classification service module 112, business application module 130, metadata manager module 106, and/or any other suitable data source. Interface 202 may also include any suitable software operable to transmit data to various devices such as user 10, device 104, data classification service module 112, business application module 130, metadata manager module 106, and/or any other suitable device. Interface 202 may include one or more ports, conversion software, or both.

In some embodiments, input device 212 may refer to any suitable device operable to input, select, and/or manipulate various data and information. Input device 212 may include, for example, a keyboard, mouse, graphics tablet, joystick, light pen, microphone, scanner, or other suitable input device. Output device 214 may refer to any suitable device operable for displaying information to a user. Output device 214 may include, for example, a video display, a printer, a plotter, or other suitable output device.

Modifications, additions, or omissions may be made to system 200 without departing from the scope of the invention. For example, system 200 may include any number of processors 204, memory 206, interfaces 202, input devices 212, and/or output devices 214. Furthermore, the components of system 200 may be integrated or separated. For example, in particular implementations, memory 206 may be integrated as a single component with metadata manager database 208 or application data stores 144.

FIG. 3 is an example flowchart for a metadata catalog. In some embodiments, metadata elements are automatically updated based on the detection of an event. The method begins at step 302 where data classification module 112 detects an event. Classification module may detect the event through expiry of a timer and/or from device 104. At step 304, data classification service module 112 determines whether a metadata element is affected by the event. Data classification service module 112 may make this determination through application of classification rules 122 as discussed previously. If data classification service module 112 does not determine that a metadata element is affected by the event, the method proceeds to step 310 where the method is terminated. If, however, data classification service module 112 does determine that a metadata element is affected by the event, the method proceeds to step 306 where data classification service module determines an updated classification value for the metadata element.

At step 306, data classification service module 112 determines an updated classification value for the affected metadata element as discussed previously. Data classification service module 112 may apply classification rules 122 to make this determination as discussed. Data classification service module may communicate the updated classification value to metadata manager module 106 and/or business application module 130 via network 110.

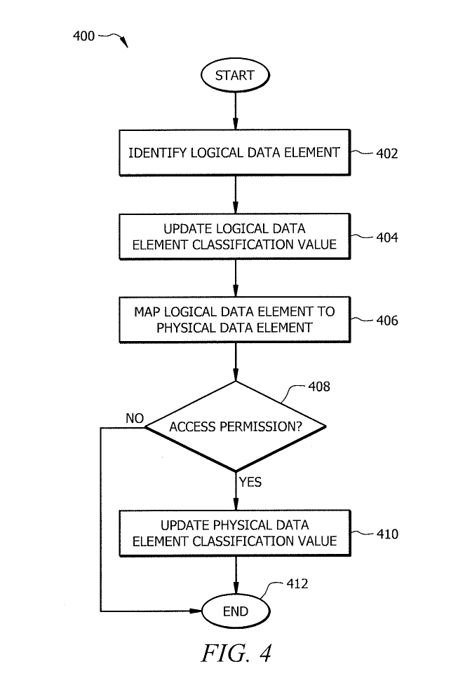

At step 308, system 100 dynamically modifies metadata elements associated with the updated classification value. This step may be completed by metadata manager module 106 and/or business application module 130. This step is discussed in more detail in the disclosure relating to FIG. 4. Next, the method proceeds to step 310 where the method is terminated.

Modifications, additions, or omissions may be made to the method depicted in FIG. 3. The method may include more, fewer, or other steps. For example, steps may be performed in parallel or in any suitable order. For simplicity, FIG. 3 describes an example in which an event affects a single metadata element. However, in other embodiments, an event may affect multiple metadata elements. As an example, if a government introduces a new requirement requiring financial institutions to report financial accounts having certain characteristics, system 100 may dynamically identify all of the financial accounts affected by the new requirement and change the classification value for their respective “report financial account” metadata elements from “no” to “yes.”

FIG. 4 is an example flowchart for dynamically modifying a metadata element. In some embodiments, system 100 may update a logical data element 126 and/or a physical data element 146 based on the updated classification value. The method begins at step 402 where data classification service module 112 identifies one or more logical data elements 126 associated with the updated classification value determined in the method illustrated in FIG. 3. Data classification service module 112, through application of classification rules 122, determines one or more logical data elements 126 associated with the updated classification value, the logical data elements 126 located in one or more metadata manager databases 108. Once the logical data elements 126 are determined, data classification service module communicates the updated classification value to the corresponding metadata manager modules 106 via network 110 where the logical data element classification value is updated at step 404.

At step 404, metadata manager module 106 updates the identified logical data element 126's classification value. As discussed previously, metadata manager module 106 applies standardization rules 124 and transformation rules 140 to update the identified logical data element 126's classification value. The method proceeds to step 406 where metadata manager module 106 maps the logical data element 126 to each associated physical data element 146 and communicates the logical data element 126 to the physical data element 146's corresponding business application module 130.

Business application module 130 determines whether the source of the event has permission to modify the associated physical data element 146 at step 408. As discussed previously, physical data elements 146 may be classified in a way where only certain sources or users may modify the physical data elements 146. If business application module 130 determines that the source does not have permission, the method proceeds to step 412 where it is terminated. If, however, business application module 130 determines that the source does have permission, then the method proceeds to step 410 where business application module 130 updates the classification value of physical data element 146. After the physical data element classification value is updates, the method proceeds to step 412 where the method is terminated.

Modifications, additions, or omissions may be made to the method depicted in FIG. 3. The method may include more, fewer, or other steps. For example, only the logical data elements 126 associated with the updated classification value may be updated. As another example, only the physical data elements 146 may be updated. As a further example, steps may be performed in parallel or in any suitable order.

Although the present disclosure has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system comprising:
memory configured to maintain a plurality of metadata elements, each metadata element indicating a current classification value for user data described by that metadata element; and
one or more processors configured to:
detect the occurrence of an event;
automatically determine which of the metadata elements are affected by the event; and
for each metadata element affected by the event:
automatically determine an updated classification value for the user data described by that metadata element; and
dynamically modify the metadata element to indicate the updated classification value.

2. The system of claim 1, wherein the event is a time-based event.

3. The system of claim 1, wherein the event is initiated by a user.

4. The system of claim 1, wherein to dynamically modify the metadata element to indicate the updated classification value, the one or more processors are configured to:
identify a logical data element associated with the metadata element;
modify the logical data element to contain the updated classification value;
map the logical data element to a physical data element;
determine a source of the event;
determine whether the source has permission to modify the physical data element; and
upon a determination that the source has permission to modify the physical data element, modify the physical data element to contain the updated classification value.

5. The system of claim 4, wherein the physical data element is not modified upon a determination that the source does not have permission to modify the physical data element.

6. The system of claim 4, wherein the one or more processors identifies a plurality of logical data elements.

7. The system of claim 6, wherein each of the plurality of logical data elements is associated with different transformation rules.

8. Non-transitory computer readable medium comprising logic, the logic, when executed by a processor, operable to:
detect the occurrence of an event;
automatically determine which of a plurality of metadata elements are affected by the event, wherein each metadata element indicates a current classification value for user data described by that metadata element; and
for each metadata element affected by the event:
automatically determine an updated classification value for the user data described by that metadata element; and
dynamically modify the metadata element to indicate the updated classification value.

9. The medium of claim 8, wherein the event is a time-based event.

10. The medium of claim 8, wherein the event is initiated by a user.

11. The medium of claim 8, wherein to dynamically modify the metadata element to indicate the updated classification value, the logic, when executed by a processor, is further operable to:
identify a logical data element associated with the metadata element;
modify the logical data element to contain the updated classification value;
map the logical data element to a physical data element;
determine a source of the event;
determine whether the source has permission to modify the physical data element; and
upon a determination that the source has permission to modify the physical data element, modify the physical data element to contain the updated classification value.

12. The medium of claim 11, wherein the physical data element is not modified upon a determination that the source does not have permission to modify the physical data element.

13. The medium of claim 11, wherein the one or more processors identifies a plurality of logical data elements.

14. A method comprising:
detecting, by a processor, the occurrence of an event;
automatically determining which of a plurality of metadata elements are affected by the event, wherein each metadata element indicates a current classification value for user data described by that metadata element; and
for each metadata element affected by the event:
automatically determining an updated classification value for the user data described by that metadata element; and
dynamically modifying the metadata element to indicate the updated classification value.

15. The method of claim 14, wherein the event is a time-based event.

16. The method of claim 14, wherein the event is initiated by a user.

17. The method of claim 14, wherein dynamically modifying the metadata element to indicate the updated classification value comprises:
identifying a logical data element associated with the metadata element;
modifying the logical data element to contain the updated classification value;
mapping the logical data element to a physical data element;
determining a source of the event;
determining whether the source has permission to modify the physical data element; and
upon a determination that the source has permission to modify the physical data element, modifying the physical data element to contain the updated classification value.

18. The method of claim 17, wherein the physical data element is not modified upon a determination that the source does not have permission to modify the physical data element.

19. The method of claim 17, wherein the processor identifies a plurality of logical data elements.

20. The method of claim 19, wherein each of the plurality of logical data elements is associated with different transformation rules.
